(19) United States
(12) Patent Application Publication
(10) Pub. No.: US 2010/0071616 A1
(43) Pub. Date: Mar. 25, 2010

(54) COATING POWDER FILTER DEVICE

(75) Inventors: Felix MAUCHLE, Abtwil (CH); Mark STEINEMANN, Hofstetten (CH); Silvano GELAIN, Abtwil (CH)

Correspondence Address: LOWE, HAUPTMAN, HAM & BERNER, LLP (ITW), 1700 DIAGONAL ROAD, SUITE 300, ALEXANDRIA, VA, 22314, US

(73) Assignee: ITW GEMA AG, St. Gallen (CH)

(21) Appl. No.: 12/523,061

(22) PCT Filed: Jan. 24, 2008
(86) PCT No.: PCT/IB08/00155

§ 371 Date: Jul. 14, 2009

(30) Foreign Application Priority Data
Feb. 2, 2007 (DE) 10 2007 005 310.1

(51) Int. Cl. B05C 19/06

(52) U.S. Cl. 118/308; 118/326

(57) ABSTRACT

A coating powder filtration system containing a fluidizing unit to fluidize coating powder upstream of a powder outlet.

The present invention relates to a coating powder filter device, hereafter coating powder filtration system, defined in the preamble of claim 1 in particular to be used in a powder spraycoating facility.

Known filtration systems contain at least one filter element permeable to an air flow but impermeable to powder particles contained in said flow. The filter element may be a filtering bag, a filtering cartridge or a filtering plate or any other filter element. When the filter element is a solid, it consists preferably of a material containing air-permeable pores.

Illustratively a powder spraycoating facility is known from U.S. Pat. No. 3,918,641 and German patent document DE 42 39 496 A1. Only the latter document diagrammatically shows a filter 62.

The object of the present invention is to so design coating powder filtration systems that they allow versatile application.

The present invention solves this problem by the features of claim 1.

Accordingly the present invention relates to a coating powder filtration system containing a housing; an airflow outlet in the upper housing segment for a blower's air flow; an air/powder mixed flow intake in the upper housing segment; at least one filter element in the upper housing segment in the flow path between the air/powder mixed flow intake and the air flow outlet, said element being impermeable to the coating powder for the purpose of retaining coating powder from the air/powder mixed flow but permeable to air; a powder outlet in the lower housing segment to discharge powder that is retained by the minimum of one filter element and that drops into the lower housing segment; where the powder outlet is lower than the lower end of the minimum of one filter element, characterized in that a fluidizing unit is included to fluidize coating powder in the lower housing segment upstream of the powder outlet.

The present invention is elucidated below by preferred and illustrative embodiment modes in relation to the appended drawings.

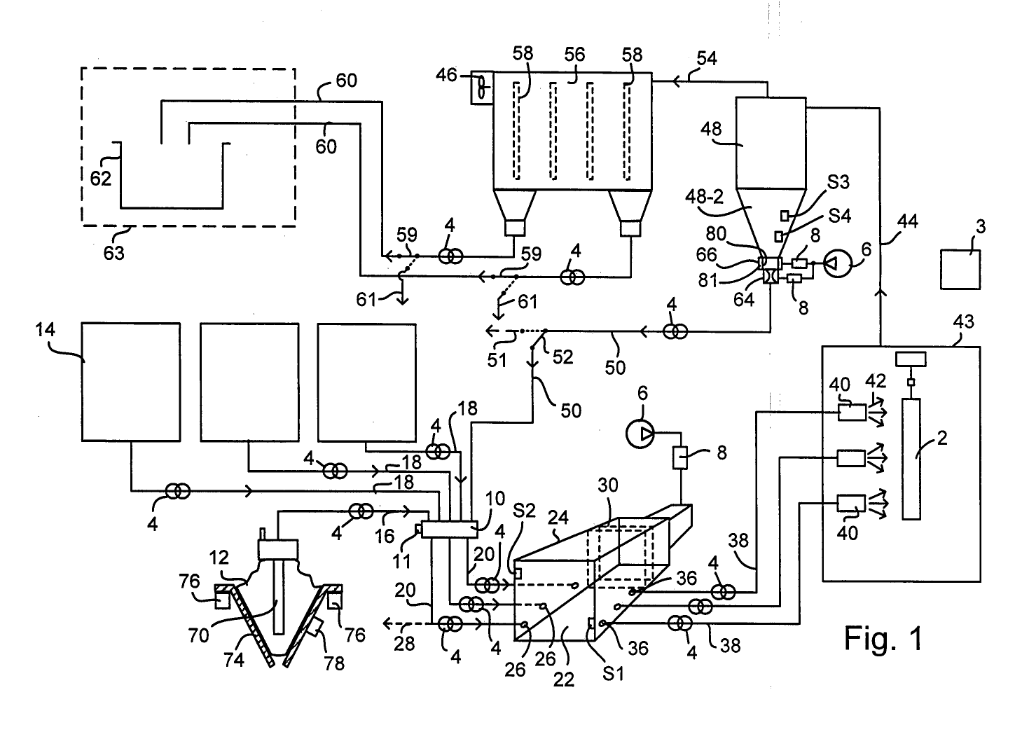

FIG. 1 illustrates a powder spraycoating facility fitted with a filtration system of the present invention,

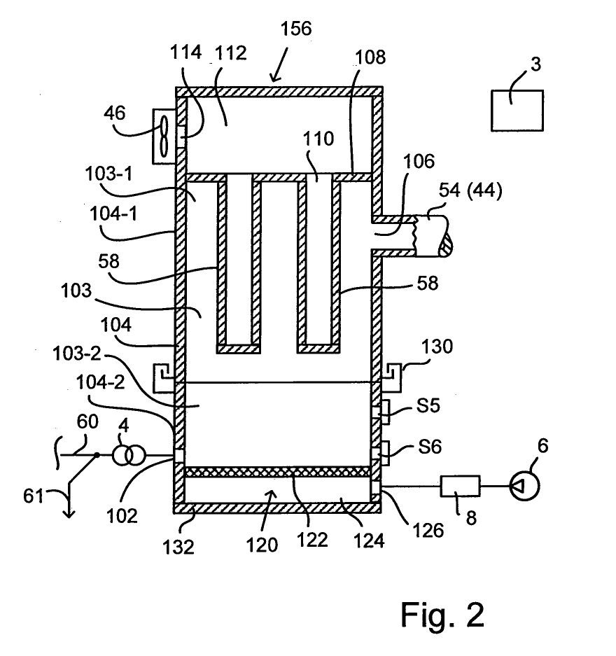

FIG. 2 is a vertical section of a preferred embodiment mode of a filtration system of the present invention,

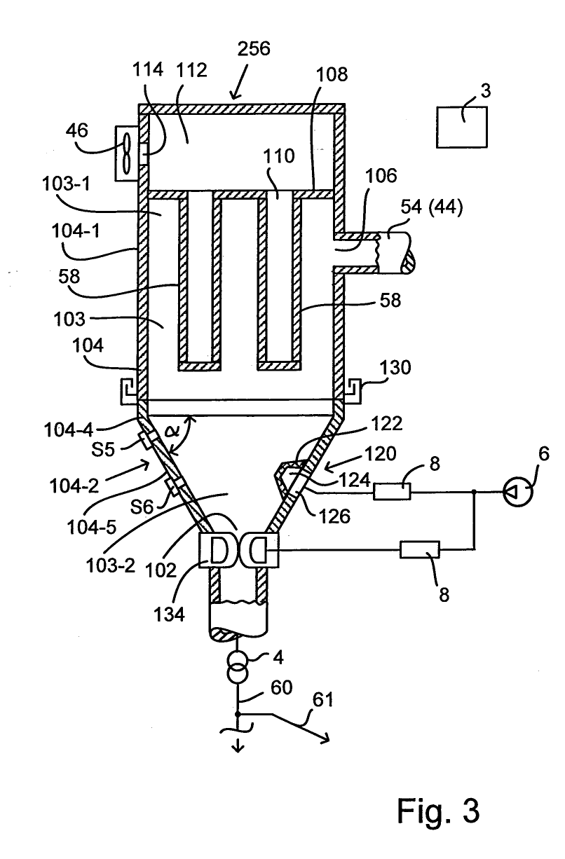

FIG. 3 is a vertical section of a further preferred embodiment mode of a filtration system of the present invention,

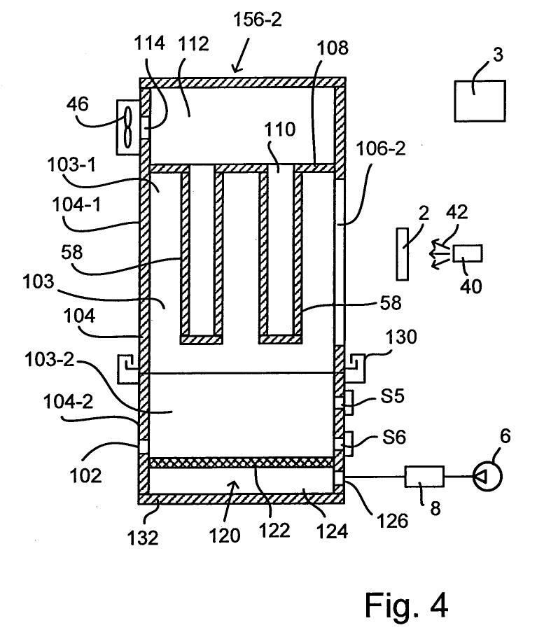

FIG. 4 is a filtration system of the invention open to the outside, and

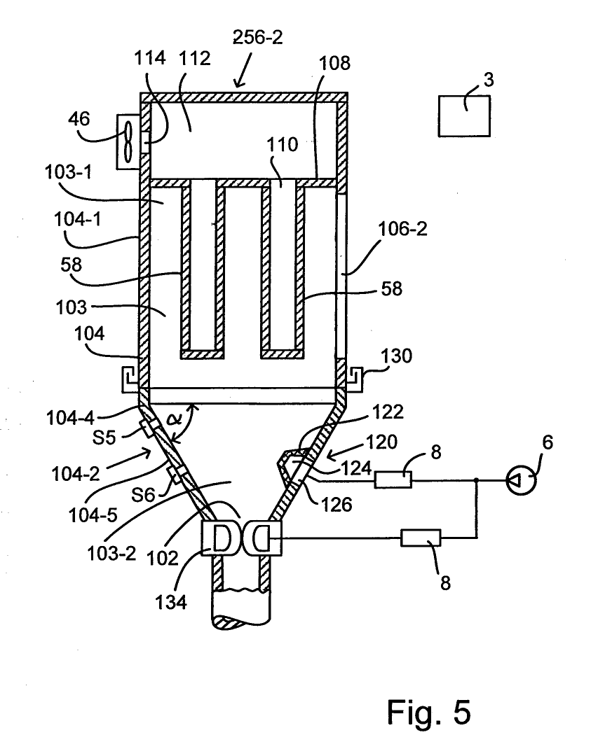

FIG. 5 is another embodiment mode of the present invention of a filtration system open to the outside.

FIG. 1 shows diagrammatically a preferred embodiment mode of a powder spraycoating facility of the invention to spray objects 2 to be coated with coating powder which thereupon is made to melt onto the object within an omitted oven. One or more electronic controls 3 are used to drive the operations of the powder spraycoating facility. Powder pumps 4 are used to pneumatically move the coating powder. Said pumps may be injectors wherein compressed air acting as the conveying air aspirates coating powder out of a powder container, whereupon the mixture of conveying air and coating powder flows jointly into a container or to a sprayer.

Illustratively injectors are known from the European patent document EP 0 412 289 B1.

The powder pump(s) used may also be of the kind wherein a small powder portion (amount of powder) is stored in a powder chamber and then is expelled by compressed air out of said chamber. The compressed air remains behind the powder portion and drives it in front of it. Such pump types sometimes are called plug moving pumps because the compressed air pushes the stored powder portion before it as if it were a plug through a pump outlet conduit. Various kinds of such powder pumps moving dense coating powders illustratively are known from the following documents: DE 103 53 968 A1; U.S. Pat. No. 6,508,610 62; US 2006/0193704 A1; DE 101 45 448A1 and WO 2005/051549A1.

The invention is not restricted to one of the cited kinds of pumps.

A compressed air source 6 generates the compressed air used to move the coating powder and to fluidize it, said source being connected by corresponding pressure adjusting elements 8 such as pressure regulators and/or valves to the various components.

Freshly delivered powder for instance in the form of a small vendor container 12, for instance in the form of a dimensionally stable container or a bag holding 10 to 50 kg, for instance 25 kg of powder, or in the form of a large container 14, illustratively again a dimensionally stable container or a bag holding for instance 100 to 1,000 kg of powder, is fed by a powder pump 4 configured in a fresh-powder manifold conduit 16 or 18 to a sieve 10. The sieve 10 may be fitted with a vibrator 11. In the description to follow, the expressions “small container” and “large container” each denote a “dimensionally stable container” as well as “non-rigid, flexible bag”, unless there be a specific reference to another kind of container.

The coating powder sifted by the sieve 10 is moved by gravity or preferably each time by a powder pump 4 through one or more powder feed conduits 20 and through powder intake apertures 26 into an intermediate receptacle chamber 22 of a dimensionally stable intermediate receptacle 24. The volume of the intermediate receptacle chamber 22 is preferably substantially smaller than the volume of the small fresh powder container 12.

In a preferred embodiment mode of the invention, the powder pump 4 of the minimum of one powder feed conduit 20 leading to the intermediate receptacle 24 is a compressed air pump. In this instance the initial segment of the powder feed conduit 20 may serve as a pump chamber which receives the powder sifted through the sieve 10 as it drops through a valve, for instance a pinch valve. Once this pump chamber contains a given powder portion, the powder feed conduit 20 is shut off from the sieve 10 by means of valve closure. Next the powder portion is forced by compressed air through the powder feed conduit 20 into the intermediate receptacle chamber 22.

Preferably the powder intake apertures 26 are configured in a sidewall of the intermediate receptacle 24, preferably near the bottom of the intermediate receptacle chamber 22, so that, when compressed air flushes the intermediate receptacle chamber 22, even powder residues at the bottom can be expelled through the powder intake apertures 26, and for that purpose the powder feed conduits 20 preferably are separated from the sieve 10 and point into a waste bin as indicated by a dashed arrow 28 in FIG. 1. The intermediate receptacle chamber 22 is cleaned for instance by a plunger 30 that is fitted with compressed air nozzles and that is displaceable through the intermediate receptacle chamber 22.

Powder pumps 4, for instance injectors, are connected to one or more powder outlet apertures 36 to move coating powder through powder conduits 38 to the spray coating means 40. The spray means 40 may be fitted with spray nozzles or rotary atomizers to spray coating powder 42 onto the object 2 to be coated, said object being situated in a coating cabin 43. Preferably the powder outlet apertures 36 are situated in a wall that is opposite the wall containing the powder intake apertures 26. Preferably the powder outlet apertures 36 also are configured near the bottom of the intermediate receptacle chamber 22.

Preferably the size of the intermediate receptacle chamber 22 is selected to allow storing coating powder in amounts between 1.0 and 12 kg, preferably between 2.0 and 8.0 kg. In other words, the size of the intermediate receptacle chamber 22 preferably shall be between 500 and 30,000 cm³, preferably between 2,000 and 20,000 cm³. The size of the intermediate receptacle chamber 22 is selected as a function of the number of powder outlet apertures 36 and powder conduits 38 connected to them in a manner to allow continuous spraycoating while also allowing rapidly cleaning the intermediate receptacle chamber 22 during intermissions in operation for purposes of powder changes, preferably in automated manner. The intermediate receptacle chamber 22 may be fitted with a fluidizing unit to fluidize the coating powder.

Coating powder 42 failing to adhere to the object 2 is aspirated as excess powder through an excess powder conduit 44 by a flow of suction air from a blower 46 into a cyclone separator 48. In the cyclone separator, the excess powder is separated as much as possible from the suction flow. The separated powder proportion is then moved as recovered powder from the cyclone separator 48 through a recovery powder conduit 50 to the sieve 10 and from there it passes through said sieve, either by itself or admixed to fresh powder, through the powder feed conduits 20, once more into the intermediate receptacle chamber 22.

Depending on the kind of powder and/or the intensity of powder soiling, the powder recovery conduit 50 also may be separated from the sieve 10 and move the recovery powder into a waste bin as schematically indicated by a dashed line 51 in FIG. 1. In order that the powder recovery conduit need not be separated from the sieve 10, it may be fitted with a switch allowing connecting it either to the sieve 10 or to a waste bin.

The intermediate receptacle 24 may be fitted with one or more sensors, for instance two sensors S1 and/or S2 to control feeding coating powder into the intermediate receptacle chamber 22 by means of the control 3 and of the powder pumps 4 in the powder feed conduits 20. Illustratively the lower sensor S1 detects a lower powder level limit and the upper sensor S2 detects an upper powder level limit.

The lower end segment 48-2 of the cyclone separator 48 can be designed and used as a recovery powder supply container and be used as such and be fitted for that purpose with one or several, illustratively two sensors S3 and/or S4 which are operationally connected to the control 3. As a result the fresh powder feed through the fresh powder feed conduits 16 and 18 may be stopped, especially in automated manner, until enough recovery powder shall accumulate in the cyclone separator 48 to feed, through the sieve 10, enough recovery powder into the intermediate receptacle chamber 22 for spraycoating using the sprayer 40. Once the recovery powder becomes insufficient in the cyclone separator 48 for such operation, the switchover to the fresh powder feed through the fresh powder conduits 16 or 18 may automatically kick in. The invention also offers the possibility to simultaneously feed fresh and recovery powders to the sieve 10 to admix them to one another.

The exhaust air of the cyclone separator 48 passes through an exhaust air conduit 54 into a post filtration system 56 and therein through one or more filter elements 58 to arrive at the blower 46 and beyond latter into the atmosphere. The filter elements 58 may be filter bags or filter cartridges or filter plates or similar elements. Ordinarily the powder separated from the air flow by means of the filter elements 58 is waste powder and drops by gravity into a waste bin, or, as shown in FIG. 1 it may be moved by means of one or several waste conduits 60 each fitted with a powder pump 4 into a waste bin 62 at a waste station 63.

Depending on the kind of powder and on the powder coating conditions, the waste powder also may be recovered and moved to the sieve 10 in order to be recirculated into the coating circuit. This feature is schematically indicated in FIG. 1 by switches 59 and branch conduits 61 of the waste conduits 60.

Typically only cyclone separators 48 and the post filtration system 56 are used for multicolor operation, wherein different colors each are sprayed only for a short time, and the waste powder of the post filtration system 56 is moved into the waste bin 62. In general the powder-separating efficiency of the cyclone separator 48 is less than that of the post filtration system 56, but cleaning is more rapid than in the post filtration system 56. As regards monochrome operation, wherein the same powder is used for a long time, the cyclone separator 48 may be dispensed with, and the excess powder conduit 44 instead of the exhaust air conduit 54 may be connected to the post filtration system 56, and the waste conduits 60—which in this instance contain recovery powder—are connected as powder recovery conduits to the sieve 10. Typically the cyclone separator 48 is used in combination with the post filtration system 56 in monochrome operation only when the coating powder entails problems. In such eventuality only the recovery powder of the cyclone separator 48 is moved through the powder recovery conduit 50 to the sieve 10 whereas the waste powder of the post filtration system 56 is moved into the waste bin 62 or into another waste bin, said waste bin being optionally free of waste conduits 60 and directly positioned underneath an outlet aperture of the post filtration system 56.

The lower end of the cyclone equipment 48 may be fitted with an outlet valve 64, for instance a pinch valve. Moreover a fluidizing unit 66 to fluidize the coating powder may be configured above said outlet valve 64, in or at the lower end segment 48-2, constituted as a supply container of the cyclone separator 48. The fluidizing unit 66 contains at least one fluidizing wall 80 made of material comprising open pores or fitted with narrow boreholes, this material passing compressed air but not the coating powder. The fluidizing wall 80 is situated between the powder path and a fluidizing compressed air chamber 81. The fluidizing compressed air chamber 81 may be connected by a compressed air adjusting element 8 to the compressed air source 6.

For the purpose of evacuating fresh coating powder by suction, the fresh powder conduit 16 and/or 18 may be connected to a powder moving pipe 70 at is upstream end either directly or through the powder pump 4 to allow powder flow, said pipe being dippable into the vendor's container 12 or 14. The powder pump 4 may be mounted at the beginning of, the end of, or in-between, in the fresh powder conduit 16 or 18 or at the upper or lower end of the powder moving pipe 70.

A small fresh powder container in the form of a fresh powder bag 12 is shown in FIG. 1 being held in a bag-receiving hopper 74. The bag-receiving hopper 74 keeps the powder bag 12 in a specified shape, the bag opening being at the upper bag end. The bag-receiving hopper 74 may be mounted on a scale or on weight sensors 76. Depending on their design, these scale or weight sensors may generate visual displays and/or electrical signals that, following subtraction of the weight of the bag-receiving hopper 74, will correspond to the weight and hence the quantity of the coating powder in the small container 12. Preferably a minimum of one vibrator 78 is mounted at the bag-receiving hopper 74 to vibrate it.

Two or more small containers 12 may be configured each in one bag-receiving hopper 74, also two or more large containers 14 operating alternately. This feature allows rapidly changing from one small container 12 to another or one large container 14.

The invention may be modified in a number of ways without restricting it. For instance the sieve 10 may be integrated into the intermediate receptacle 24. Alternatively the sieve 10 may be omitted when the fresh powder quality is high enough. In that case a separate sieve may be used to sift the recovery powder of the conduits 44 and 50, illustratively upstream or downstream of the cyclone separator 48 or in it. Again, sifting the recovery powder will not be required when its quality is adequate for re-use.

FIG. 2 is a vertical section of a special embodiment mode of a filtration system 156 which may be used instead of the filtration system 56 of FIG. 1 and also for other purposes. FIG. 2 diagrammatically shows only one powder outlet 102 for recovery powder or for waste powder, whereas FIG. 1 diagrammatically shows two such powder outlets. However all embodiment modes may comprise one, two or more powder outlets.

The embodiment mode of FIG. 2 comprises a housing 104 bounding a powder recovery chamber 103. Said chamber is sealed relative to the atmosphere preferably in powder-impermeable manner. The powder recovery chamber 103 comprises a filter chamber 103-1 in an upper housing segment 104-1 and, as a lower continuation of the filter chamber segment 103-1, a powder collecting zone 103-2 with a chamber bottom in a lower housing segment 104-2. The minimum of one filter element 58 is configured in the filter chamber segment 103-1. At least one powder outlet 102 abutting the chamber bottom is configured at the lower end of the powder collecting zone 103-2 in a side wall of the lower housing segment 104-2, for the purpose of draining coating powder that is retained by the minimum of one filter element 58 from the air/powder mixed flow and that drops into the powder collecting zone 103-2 of the lower housing segment 104-2. The powder collecting zone 103-2 is a continuous lower extension of the filter chamber segment 103-1. The inner surfaces of these segments and zones run in stepless manner from top to bottom so that coating powder is able to drop from the filter chamber 103-1 into the powder collecting zone 103-2 and also can slip downward along the inside surfaces.

Moreover the housing 104 is fitted in the upper housing segment 104-1, in the filter chamber zone 103-1, with a air/powder mixed flow intake 106 to which may be connected the waste air conduit 54 of the cyclone separator 48 or the downstream end of the excess powder conduit 44.

FIG. 2 illustratively shows two filter elements 58 in the form of filtering cartridges or filtering bags. However only one filter element 58 or more than two also might be used. These filter elements 58 for instance are tubular or bag-like or pouch-shaped hollow structures. Said elements are suspended in the upper housing segment 104-1 from the hermetic intermediate ceiling 108, the inside space of the filter elements communicating flow-wise each through an opening 110 of said intermediate ceiling 112 with an airflow outlet chamber 112. The airflow outlet chamber 112 is fitted with an airflow outlet aperture 114 to which is connected the suction side of the blower 46.

The invention includes a fluidizing unit 120 to fluidize coating powder in the lower housing segment 104-2 in the powder collecting zone 103-2 near the upstream side of the powder outlet 102.

The fluidizing unit 120 contains at least one fluidizing partition 122 separating the powder collecting zone 103-2 near the upstream side of the powder outlet 102 from a fluidizing compressed air chamber 124 and being permeable only to fluidizing compressed air while being impermeable to coating powder particles. Preferably the fluidizing wall 122 is made of an open-pore material or an air-permeable membrane. The fluidizing compressed air chamber 124 may be fed with fluidizing compressed air through a fluidizing compressed air intake.

The fluidizing unit 120 may be designed in different ways. The fluidizing partition 122 may be a straight or curving wall or a hood, the hood's inside space subtending the fluidizing compressed air chamber 124. The fluidizing partition and the fluidizing compressed air chamber may be configured in a pipe-end entering the powder collecting zone of the powder recovery chamber 103.

In the filter unit 156 of the invention shown in FIG. 2, the fluidizing partition 122 constitutes the chamber bottom of the powder collecting zone 103-2 in the lower housing segment 104-2, underneath and directly next to the powder outlet 102. The fluidizing partition 122 as such is configured between the powder recovery chamber 103 and the fluidizing compressed air chamber 124. Said chamber is bounded at its base by a housing bottom 132. The fluidizing compressed air chamber 124 is fitted with the fluidizing compressed air intake 126 to which the compressed air source 6 can be connected by means of one or more control elements 8 such as valves and/or pressure regulator(s).

The fluidizing partition 122 may constitute in whole or in part the chamber bottom or a portion of a side wall of the lower housing segment 104-2.

The suction side of a powder pump 4 of the powder waste conduit 60 or of the powder recovery conduit 61 can be connected to the powder outlet 102.

At least one sensor S5 and/or S6 or both or more sensors are configured beneath the height of the lower end of the minimum of one filter element 58 though above the height of the powder outlet 102 to detect the powder level. Depending on said level, the sensors S5 and S6 generate a signal indicating whether or not the powder level in the lower housing segment 104-2 is at least as high or not as the pertinent sensor. The signal may be either optical or acoustic and/or an electric voltage signal or an electric current signal. Such a signal also may be in the form of the sensor being a switch opening or closing as a function of the detected powder signal.

The minimum of one sensor S5 and/or S6 preferably is connected to the control 3. This control 3 is designed to carry out at least one predetermined operation as a function of the minimum of one signal.

Illustratively the minimum of one controlled function/operation may be to drive the pump 4 of the waste conduit 60 or of the powder recovery conduit 61. This control operation may be in the form of switching ON or OFF said pump 4 as a function of the lower and upper powder level detected by the two sensors S5 and S6. For instance the pump 4 may be turned ON when the level reaches at least the upper sensor S5 and it may be turned OFF when the level has dropped to the lower sensor S6. This ON/OFF function moreover may be made to depend on other sensors transmitting further signals to the control 3, for instance a “need powder” signal from the sensor S1 of the intermediate receptacle 24. Also the ON/OFF function of the pump 4 may be made to depend on the indication from a sensor or a balance or a weighing cell 76 that the fresh powder container 21 still holds much, or little or no fresh powder.

Also the control 3 may be operationally connected to a pilot light and/or to an acoustic signal generator to emit an alarm when the powder level in the housing 104 has reached a critical height, for instance if, after turning ON the pump 4 of the waste conduit 60 or of the powder recovery conduit 61, the upper sensor S5 still indicates that the powder level remains at or above the height of said sensor S5. Also the control 3 may be designed so that it transmits an alarm signal if the lower sensor S1 of the intermediate receptacle 24 is generating a “need powder” signal while the lower sensor S6 is transmitting that it too fails to detect powder down to its level and also the sensor or the balance or the weighing cell 76 of the fresh powder container 12 displays that the quantity of fresh powder present in the fresh powder container 12 has dropped below a predetermined minimum value. The above enumeration of conceivable control variations is not exclusive, on the contrary further combinations are feasible.

The inside surfaces of the housing 104 are sloping downward from the height at the upper end of the minimum of one filter element 58 to the powder outlet 102 in a manner that powder may slide on them. For that purpose the inside surfaces of the housing 104 subtend an angle with the horizontal preferably of 90 and at least 60°. The sloping angle a is illustratively shown in FIG. 3.

The upper housing segment 104-1 and the lower housing segment 104-2 may be an integral unit or they may be joined to each other in non-detachable or preferably detachable manner for instance using a quick-connect 130. An illustratively pinch valve may be mounted in FIG. 2, as it is in FIG. 3, between the powder outlet 102 and the pump 4 connected to it.

The further embodiment mode shown in FIG. 3 of a filtering system 256 is identical with the filtering system 156 of FIG. 2 except that the lower housing segment 104-2 comprises a narrower downward hopper at least over part of its height. Components shown in FIG. 3 that fill the same function as in FIG. 2 are denoted by the same references.

The lower housing segment 104-2 of FIG. 3 may be hopper-like over its full height or, as shown in FIG. 3, comprise a circular cylindrical upper segment 104-4 and a funnel-like lower segment 104-5. The lower end of the funnel-like lower segment 104-5 is fitted with a powder outlet 102 pointing downward. Coating powder dropping off the filter elements 58 can be collected in the funnel-like lower segment 104-5. The pump 4 of the waste conduit 60 or of the powder recovery conduit 61 can be connected to the powder outlet 102, either directly as shown in FIG. 2 or through a valve 134 which is diagrammatically shown as a pinch valve.

In the embodiment mode of FIG. 3, the fluidizing wall 122 of the fluidizing unit 120 is configured as in FIG. 1 on the upstream side of the powder outlet 102, however not underneath, but above it. In FIG. 3, the fluidizing wall 122 together with the funnel-like wall can bound the fluidizing compressed air chamber 124.

In the embodiment mode of FIG. 3, the funnel-like peripheral wall of the lower housing segment 104-2 together with the valve 134 at the powder outlet 102 constitutes a chamber bottom on which coating powder filtered by the filter elements 54 out of the air/powder mixed flow and dropping down can be collected and stored.

In another embodiment mode of the invention, the fluidizing wall 122 may constitute a portion of the funnel-like wall of the funnel-like lower segments 104-5. In still another embodiment mode of the invention, the funnel-like lower housing segment 104-2 or the funnel-like lower segment 104-5 may be extended downward by a circular-cylindrical end segment. The fluidizing wall 122 may be integrated into the circular cylindrical end segment or constitute it. In yet another embodiment mode of the invention, a pipe may be used which enters the funnel-like lower segment 104-5 and comprises at its entering end at least one fluidizing wall 122 and one fluidizing compressed air chamber 124.

All the above described features also may be combined in ways other than already discussed. The filtration systems 56, 156 and 256 of FIGS. 1, 2 and 3 also may be used for other facilities than the powder spraycoating facility shown in FIG. 1.

All coating powder filtration systems of the invention also may be used in the absence of a powder pump 4 at the powder outlet 102. In such designs, the coating powder may be discharged from the powder outlet 102 by gravity instead of a powder pump.

As regards the filtration systems 56, 156 and 256 of FIGS. 1, 2 and 3, the powder recovery chamber 103 is sealed from the atmosphere in preferably powder-impermeable manner. In such filtration systems, the air/powder mixed flow intake 106 is designed as a hookup aperture for a hose or pipe 54 or 44.

FIGS. 4 and 5 show open embodiment modes 156-2 respectively 256-2 of the filtration systems 156 and 256 of FIGS. 2 and 3. As regards the open embodiment modes 156-2 and 256-2, the powder recovery chamber 103 is situated in the height range in which runs at least one filter element 58, and said chamber is at least partly open to the outside on one chamber side in the form of an open housing side 106-2 or in the form of a larger opening therein to aspirate external air and powder particles contained in it by means of the blower 46 through the minimum of one filter element 58. In this manner such open filtration systems 156-2 and 256-2 can serve to suck powder-carrying air out of the atmosphere and thus clean it, for instance when coating powder is transferred from one container into another or at open spraycoating sites. FIGS. 4 and 5 illustratively show an open spraycoating site fitted with one of the filtration systems 156-2 or 256-2. They are configured opposite one or several sprayers 40 behind an object 2 to be coated.

1. A coating powder filtration system containing a housing, an airflow outlet in the upper housing segment for the airflow from a blower; an air/powder mixed flow intake in the upper housing segment; at least one filter element in the upper housing segment in a flow path between the air/powder mixed flow intake and the airflow outlet, said element being impermeable to coating powder from the air/powder mixed flow and designed to retain it, but being permeable to air; a powder outlet in the lower housing segment to discharge powder being retained by at least one filter element and dropping into the lower housing segment; where the powder outlet is configured lower than the lower end of the minimum of one filter element;
characterized
in that the coating powder filtration system includes a fluidizing unit to fluidize coating powder in the lower housing segment upstream of the powder outlet.

2. Coating powder filtration system as claimed in claim 1, characterized in that the lower housing segment underneath the minimum of one filter element is fitted with a chamber bottom impermeable to coating powder or constitutes a chamber bottom impermeable to coating powder, said bottom receiving coating powder from the minimum of one filter element.

3. Coating powder filtration system as claimed in claim 1, characterized in that the fluidizing system comprises at least one fluidizing partition separating the segment of the housing inside space situated in the lower housing segment from a fluidizing compressed air chamber and permeable only to the fluidizing compressed air but not to the coating powder, and in that the fluidizing compressed air chamber is fitted with a fluidizing compressed-air intake.

4. Coating powder filtration system as claimed in claim 2, characterized in that the minimum of one fluidizing partition constitutes at least part of a chamber bottom receiving coating powder dropping from the minimum of one filter element or is part of a chamber wall near the powder outlet.

5. Coating powder filtration system as claimed in claim 3, characterized in that the fluidization partition is situated lower than the powder outlet.

6. Coating powder filtration system as claimed in claim 3, characterized in that the fluidization partition is situated higher than the powder outlet.

7. Coating powder filtration system as claimed in claim 1, characterized in that the powder outlet is or can be connected to the suction side of powder pump.

8. Coating powder filtration system as claimed in claim 1, characterized in that the minimum of one sensor below the height of the lower end of the minimum of one filter element however is situated above the height of the powder outlet to detect the level of the powder in the housing.

9. Coating powder filtration system as claimed in claim 8, characterized in that the minimum of one sensor (S5, S6) is operationally connected to a control designed to implement at least one predetermined operation as a function of the signals from said sensor(s).

10. Coating powder filtration system as claimed in claim 9, characterized in that the said minimum of one operation of the control includes at least turning ON and/or turning OFF the powder pump as a function of the sensor signal from the minimum of one sensor (S5, S6).

11. Coating powder filtration system as claimed in claim 9, characterized in that the said minimum of one operation of the control at least includes generating an alarm signal as a function of the sensor signal when the detected powder signal indicates a predetermined maximum powder level was exceeded.

12. Coating powder filtration system as claimed in claim 9, characterized in that the said minimum of one operation of the control includes generating an alarm signal when the detected powder level drops below a predetermined minimum powder level.

13. Coating powder filtration system as claimed in claim 9, characterized in that the control is fitted with a time delay by means of which at least one of the said minimum of one operation can only be carried out after a predetermined time delay.

14. Coating powder filtration system as claimed in claim 1, characterized in that the inside surfaces of the housing of the upward side of the minimum of one filter element is sloping downward, in the region between the minimum of one filter element and the powder outlet, from top to bottom, in a way that coating powder can slide off said inside surfaces.

15. Coating powder filtration system as claimed in claim 1, characterized in that the region of the housing inside space-containing the upstream side of the minimum of one filter element, the air/powder mixed flow intake and the powder outlet is powder-impermeably tight relative to the atmosphere.

16. Coating powder filtration system as claimed in claim 1, characterized in that the air/powder mixed flow intake is an open side of, or a side aperture in, the upper housing segment.
